(19) United States
(12) Patent Application Publication
(10) Pub. No.: US 2015/0190772 A1
(43) Pub. Date: Jul. 9, 2015

(54) Micellar Composition Having Switchable Viscosity

(71) Applicant: QUEEN'S UNIVERSITY AT KINGSTON, Kingston (CA)

(72) Inventors: Philip G. Jessop, Kingston (CA); Michael F. Cunningham, Kingston (CA); Xin Su, Kingston (CA)

(73) Assignee: QUEEN'S UNIVERSITY AT KINGSTON, Kingston (CA)

(21) Appl. No.: 14/419,164

(22) PCT Filed: Aug. 2, 2013
(86) PCT No.: PCT/CA2013/050603

§ 371 Date: Feb. 2, 2015

Related U.S. Application Data
(60) Provisional application No. 61/679,055, filed on Aug. 2, 2012.

(51) Int. Cl. B01F 17/00

(52) U.S. Cl. CPC B01F 17/0057

(57) ABSTRACT

The present application provides a micellar composition having switchable viscosity. In accordance with an aspect of the present invention, there is provided a micellar composition comprising: (a) a mixture of water and a switchable component comprising: (i) a non-switchable surfactant and a switchable water additive; (ii) a switchable anionic surfactant; or (iii) a switchable cationic surfactant; and (b) dissolved CO₂, wherein when the switchable component comprises a non-switchable surfactant and a switchable water additive or a switchable cationic surfactant, the dissolved CO₂ is present at an amount sufficient to reversibly maintain at least a substantial portion of the switchable component in the form of wormlike micelles in the water and removal of the dissolved CO₂ reversibly decreases viscosity of the mixture by disrupting the wormlike micelles and/or converting the wormlike micelles into spherical micelles, and wherein when the switchable component comprises a switchable anionic surfactant the dissolved CO₂ is present at an amount sufficient to reversibly inhibit formation of wormlike micelles and removal of the dissolved CO₂ reversibly increases viscosity of the mixture by causing the formation of wormlike micelles.

### FIELD OF THE INVENTION

The present application pertains to the field of surfactant compositions. More particularly, the present application relates to solutions of wormlike micelles having switchable viscosity.

### BACKGROUND

Aqueous solutions having switchable viscosity can be used for several applications, such as, for example, enhanced oil recovery (EOR) and fracturing fluids for shale gas. In the case of EOR, water or an aqueous solution is used to push up the oil but this water or aqueous solution needs to be more viscous than the oil, in order to inhibit or minimize water breaking through the oil by “fingering”. The kinematic viscosity of light, medium and heavy crude oils is temperature dependent. It is suggested that the aqueous solution used in EOR requires a high viscosity in order for it to function adequately in pushing up the oil. However, the aqueous solution also needs to have viscosity that is approximately the same as that of normal water when it exits the production hole. These requirements mean that the aqueous solution used in EOR should have switchable viscosity.

Surfactants can form very long and highly flexible aggregates, referred to as “wormlike” or “threadlike” micelles. Above a critical concentration, wormlike micelles can entangle into a transient network, which displays remarkable viscoelastic properties. Viscoelastic wormlike micelles formed by low molecular weight compounds have considerable viscosity. Switchable wormlike micelles are one type of stimuli-responsive smart fluids that have a switchable viscosity. Switchable wormlike micelles can be reversibly regulated by exposure to the external stimulus or “trigger”. To date, switchable wormlike micelles have been developed that can be switched using UV/VIS-light, pH or they are electro-active (i.e., they switch via a redox reaction).

While these wormlike micelles demonstrate switchability, they are not viable for commercial use from an industrial or environmental standpoint due to the need for expensive, complex surfactant synthesis, the use of toxic moieties and/or because the trigger for switching the surfactant is typically addition of further chemicals such as oxidants and reductants or acids and bases that could cause product contamination and result in unnecessary waste production. Furthermore, reported switchable surfactants that make use of a photochemical trigger are not feasible because of, for example, the nontransparency of the resulting aqueous solution or mixtures containing such solutions, or because the solution is to be used in a dark environment such as in an underground reservoir.

This background information is provided for the purpose of making known information believed by the applicant to be of possible relevance to the present invention. No admission is necessarily intended, nor should be construed, that any of the preceding information constitutes prior art against the present invention.

### SUMMARY

An object of the present application is to provide a micellar composition having switchable viscosity. In accordance with an aspect of the present invention, there is provided a micellar composition comprising: (a) a mixture of water and a switchable component comprising: (i) a non-switchable surfactant and a switchable water additive; (ii) a switchable anionic surfactant; or (iii) a switchable cationic surfactant; and (b) dissolved CO₂, wherein when the switchable component comprises a non-switchable surfactant and a switchable water additive or a switchable cationic surfactant, the dissolved CO₂ is present at an amount sufficient to reversibly maintain at least a substantial portion of the switchable component in the form of wormlike micelles in the water and removal of the dissolved CO₂ reversibly decreases viscosity of the mixture by disrupting the wormlike micelles and/or converting the wormlike micelles into spherical micelles, and wherein when the switchable component comprises a switchable anionic surfactant the dissolved CO₂ is present at an amount sufficient to reversibly inhibit formation of wormlike micelles and removal of the dissolved CO₂ reversibly increases viscosity of the mixture by causing the formation of wormlike micelles.

In accordance with another aspect of the present invention there is provided a method of modifying the viscosity of water or an aqueous solution comprising the steps of:

(a) combining, in any order, the water or aqueous solution and a switchable component to form a first mixture having a first viscosity, wherein the switchable component is:

(i) a non-switchable surfactant and a switchable water additive;

(ii) a switchable anionic surfactant; or

(iii) a switchable cationic surfactant; and

(b) contacting the first mixture with CO₂ such that the CO₂ dissolves in the first mixture to form a second mixture having a second viscosity,
wherein when the switchable component comprises a non-switchable surfactant and a switchable water additive, or a switchable cationic surfactant, the dissolved CO₂ is present at an amount sufficient to reversibly maintain at least a substantial portion of the switchable component in the form of wormlike micelles in the water and which reversibly increases the viscosity of the second mixture over that of the first mixture,
and wherein when the switchable component comprises a switchable anionic surfactant the dissolved CO₂ is present at an amount sufficient to reversibly inhibit formation of wormlike micelles and decrease the viscosity of the second mixture to less than that of the first mixture.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 shows a series of photographs demonstrating an example of switching the viscosity of a composition comprising a non-switchable surfactant, Cl6SNa, and a switchable water additive, DMAE, at 60° C.;

FIG. 2 shows a series of photographs demonstrating the slow flowing (i.e., high viscosity) of a mixture of Cl6SNa and DMAE with dissolved CO₂ at 60° C.;

FIG. 3 graphically depicts the switchability of viscosity of a mixture of Cl6SNa and DMAE controlled by addition and removal of CO₂ at 60° C.;

FIG. 4 graphically depicts the effect of changing the surfactant Cl6SNa concentration on viscosity of the mixture in the presence of dissolved CO₂ and 200 mM switchable water additive, DMAE, at 60° C.;

FIG. 5 graphically depicts the effect of changing the surfactant Cl6SNa concentration on viscosity of the mixture in the presence of dissolved CO₂ and 200 mM switchable water additive, DMAE, at 60° C.;

FIG. 6 graphically depicts the effect of changing the concentration of switchable water additive (DMAE or TMDAB) on viscosity of a mixture containing dissolved CO₂ and 200 mM of the non-switchable surfactant Cl6SNa and at a temperature of 60° C.;

FIG. 7 graphically depicts the switchability of viscosity of a mixture of Cl8CNa and NaNO₃ in water solution controlled by addition and removal of CO₂ at 60° C.;

FIG. 8 schematically depicts the change in viscosity of a mixture of Cl8N and NaNO₃ at different temperatures and under different atmospheres.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, “aliphatic” refers to hydrocarbon moieties that are linear, branched or cyclic, may be alkyl, alkenyl or alkynyl, and may be substituted or unsubstituted. “Alkenyl” means a hydrocarbon moiety that is linear, branched or cyclic and contains at least one carbon to carbon double bond. “Alkynyl” means a hydrocarbon moiety that is linear, branched or cyclic and contains at least one carbon to carbon triple bond. “Aryl” means a moiety including a substituted or unsubstituted aromatic ring, including heteroaryl moieties and moieties with more than one conjugated aromatic ring; optionally it may also include one or more non-aromatic ring. “C₅ to C₈ Aryl” means a moiety including a substituted or unsubstituted aromatic ring having from 5 to 8 carbon atoms in one or more conjugated aromatic rings. Examples of aryl moieties include phenyl.

“Heteroaryl” means a moiety including a substituted or unsubstituted aromatic ring having from 4 to 8 carbon atoms and at least one heteroatom in one or more conjugated aromatic rings. As used herein, “heteroatom” refers to non-carbon and non-hydrogen atoms, such as, for example, O, S, and N. Examples of heteroaryl moieties include pyridyl tetrahydrofuranyl and thienyl.

“Alkylene” means a divalent alkyl radical, e.g., —C_{f}H_{2f}— wherein f is an integer. “Alkenylene” means a divalent alkenyl radical, e.g., —CHCH—. “Alkynylene” means a divalent alkynyl radical. “Arylene” means a divalent aryl radical, e.g., —C₆H₄—. “Heteroarylene” means a divalent heteroaryl radical, e.g., —C₅H₃N—. “Alkylene-aryl” means a divalent alkylene radical attached at one of its two free valencies to an aryl radical, e.g., —CH₂—C₆H₅. “Alkenylene-aryl” means a divalent alkenylene radical attached at one of its two free valencies to an aryl radical, e.g., —CHCH—C₆H₅. “Alkylene-heteroaryl” means a divalent alkylene radical attached at one of its two free valencies to a heteroaryl radical, e.g., —CH₂—C₅H₄N. “Alkenylene-heteroaryl” means a divalent alkenylene radical attached at one of its two free valencies to a heteroaryl radical, e.g., —CHCH—C₅H₄N—.

“Alkylene-arylene” means a divalent alkylene radical attached at one of its two free valencies to one of the two free valencies of a divalent arylene radical, e.g., —CH₂—C₆H₄—. “Alkenylene-arylene” means a divalent alkenylene radical attached at one of its two free valencies to one of the two free valencies of a divalent arylene radical, e.g., —CHCH—C₆H₄—. “Alkynylene-arylene” means a divalent alkynylene radical attached at one of its two free valencies to one of the two free valencies of a divalent arylene radical, e.g., —C≡C—C₆H₄—.

“Alkylene-heteroarylene” means a divalent alkylene radical attached at one of its two free valencies to one of the two free valencies of a divalent heteroarylene radical, e.g., —CH₂—C₅H₃N—. “Alkenylene-heteroarylene” means a divalent alkenylene radical attached at one of its two free valencies to one of the two free valencies of a divalent heterarylene radical, e.g., —CHCH—C₅H₃N—. “Alkynylene-heteroarylene” means a divalent alkynylene radical attached at one of its two free valencies to one of the two free valencies of a divalent arylene radical, e.g., —C≡C—C₅H₃N—.

“Substituted” means having one or more substituent moieties whose presence does not interfere with the desired reaction. Examples of substituents include alkyl, alkenyl, alkynyl, aryl, aryl-halide, heteroaryl, cycloalkyl (non-aromatic ring), Si(alkyl)₃, Si(alkoxy)₃, halo, alkoxyl, amino, alkylamino, alkenylamino, amide, amidine, hydroxyl, thioether, alkylcarbonyl, alkylcarbonyloxy, arylcarbonyloxy, alkoxycarbonyloxy, aryloxycarbonyloxy, carbonate, alkoxycarbonyl, aminocarbonyl, alkylthiocarbonyl, phosphate, phosphate ester, phosphonato, phosphinato, cyano, acylamino, imino, sulfhydryl, alkylthio, arylthio, thiocarboxylate, dithiocarboxylate, sulfate, sulfato, sulfonate, sulfamoyl, sulfonamide, nitro, nitrile, azido, heterocyclyl, ether, ester, silicon-containing moieties, thioester, or a combination thereof. Preferable substituents are alkyl, aryl, heteroaryl, and ether. It is noted that aryl halides are acceptable substituents. Alkyl halides are known to be quite reactive, and are acceptable so long as they do not interfere with the desired reaction. The substituents may themselves be substituted. For instance, an amino substituent may itself be mono or independently disubstituted by further substituents defined above, such as alkyl, alkenyl, alkynyl, aryl, aryl-halide and heteroaryl cycloalkyl (non-aromatic ring).

“Short chain aliphatic” or “lower aliphatic” refers to C₁ to C₄ aliphatic. “Long chain aliphatic” or “higher aliphatic” refers to C₅ to C₈ aliphatic.

As used herein, the term “unsubstituted” refers to any open valence of an atom being occupied by hydrogen. Also, if an occupant of an open valence position on an atom is not specified then it is hydrogen.

The term “switched” means that the physical properties and in particular the ionic strength, have been modified. “Switchable” means able to be converted from a first state with a first set of physical properties, e.g., a first state of a given ionic strength, to a second state with a second set of physical properties, e.g., a state of higher ionic strength. A “trigger” is a change of conditions (e.g., introduction or removal of a gas, change in temperature) that causes a change in the physical properties, e.g., ionic strength. The term “reversible” means that the reaction can proceed in either direction (backward or forward) depending on the reaction conditions.

As used herein, “a gas that has substantially no carbon dioxide” means that the gas has insufficient CO₂ content to interfere with the removal of CO₂ from the solution. For some applications, air may be a gas that has substantially no CO₂. Untreated air may be successfully employed, i.e., air in which the CO₂ content is unaltered; this would provide a cost saving. For instance, air may be a gas that has substantially no CO₂ because in some circumstances, the approximately 0.04% by volume of CO₂ present in air is insufficient to maintain a compound in a switched form, such that air can be a trigger used to remove CO₂ from a solution and cause switching. Similarly, “a gas that has substantially no CO₂, CS₂ or COS” has insufficient CO₂, CS₂ or COS content to interfere with the removal of CO₂, CS₂ or COS from the solution.

As used herein, “switchable water additive” refers to a compound comprising at least one amine or amidine nitrogen that is sufficiently basic that when it is in the presence of water and dissolved CO₂ (which form carbonic acid), for example, the amine or amidine nitrogen becomes protonated. When an aqueous solution that includes such a switchable additive is subjected to a trigger, the additive reversibly switches between two states, a non-ionized state where the nitrogen is trivalent and is uncharged, and an ionized state where the nitrogen is protonated making it a positively charged nitrogen atom. In some cases such as protonated amidines, the positive charge may be delocalized over more than one atom. For convenience herein, the uncharged or non-ionic form of the additive is generally not specified, whereas the ionic form is generally specified. The terms “ionized” or “ionic” as used herein in identifying a form the additive merely refer to the protonated or charged state of the amine or amidine nitrogen. For example, in certain examples, the additive includes other functional groups that are ionized when the amine or amidine nitrogen(s) is in the uncharged or non-ionic form. A detailed description of switchable water additives can be found in International PCT Publication Nos. WO 2011/097727 and WO 2012/079175, both of are incorporated herein in their entirety.

As would be readily appreciated by a worker skilled in the art, since few protonation reactions proceed to completion, when a compound is referred to herein as being “protonated” it means that all, or only the majority, of the molecules of the compound are protonated. For example, when the additive has a single N atom, more than about 90%, or more than about 95%, or about 95%, of the molecules are protonated by carbonic acid.

As used herein, “amine switchable water additive” refers to a molecule with a structure R¹R²R³N, where R¹ through R³ are independently hydrogen or optionally substituted aliphatic or aryl, which includes heteroaryl. In a specific example, one or more of R¹ through R³ is substituted with an alcohol or amine group. The ionic form of an amine is termed an “ammonium salt”. The bicarbonate salt of an amine is termed an “ammonium bicarbonate”.

As used herein, “amidine additive” refers to a molecule with a structure R¹N═C(R²)—NR³R⁴, where R¹ through R⁴ are independently hydrogen or aliphatic or aryl, which includes heteroaryl, or siloxyl, as discussed below. The ionic form of an amidine is termed an “amidinium salt”.

As used herein, the term “switchable anionic surfactant” refers to a compound comprising a hydrophobic moiety (e.g., hydrocarbon chain) represented by a wiggly line in equation (1), and a moiety comprising at least one heteroatom that is a hydrogen donor in its neutral state and a hydrogen acceptor in its anionic state. In the presence of dissolved CO₂, such a compound in aqueous solution is in a neutral state and its heteroatom is protonated. In the substantial absence of CO₂, the compound in aqueous solution is in an anionic state and its heteroatom is deprotonated and negatively charged. See equation (1) below for a generic chemical equation for this reversible reaction, where E is a heteroatom that is protonated or deprotonated by the presence or absence of CO₂ in aqueous solution.

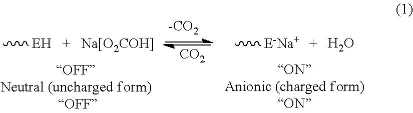

In some embodiments, E is oxygen. In some embodiments, E is part of a headgroup. In certain embodiments, the headgroup is a carboxylate moiety, as indicated in equation (2).

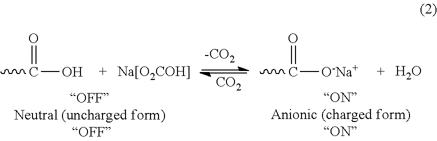

As used herein, the term “switchable cationic surfactant” refers to a compound comprising a hydrophobic portion and a nitrogen-containing portion in which the nitrogen is sufficiently basic that when it is in the presence of water and dissolved CO₂ (which form carbonic acid), for example, nitrogen becomes protonated to form a nitrogen-containing salt portion. This nitrogen-containing salt portion reversibly converts to a non-salt form upon contact with a source of heat and/or a flushing gas, wherein said flushing gas contains substantially no gas that liberates hydrogen ions in the presence of water. A detailed description of switchable cationic surfactants can be found in International PCT Publication No. WO 2007/056859, which is incorporated here in its entirety.

As used herein, the term “non-switchable surfactant” refers to a surfactant that cannot be switched between a surfactant form and a non-surfactant form by adding and removing CO₂, or vice versa, in the absence of a switchable additive.

The micellar composition and system of the present application comprises reversible wormlike micelles and can switch between a high viscosity state and a low viscosity state with the addition and removal of CO₂, or vice versa. One embodiment of this composition and system comprises a non-switchable surfactant, such as, sodium hexadecyl sulfate, in combination with a switchable water additive, such as, 2-(dimethylamino) ethanol. In another embodiment, the micellar composition and system comprises a switchable anionic surfactant, such as sodium stearate. In a third embodiment, the micellar composition and system comprises a switchable cationic surfactant, such as, N,N-dimethyl-N-octadecylamine. The size and shape of micelles in the micellar compositions depends on the geometry of the surfactant, its charge, concentration, as well as physicochemical conditions such as temperature, ionic strength, et al. In the present compositions and systems, addition and removal of CO₂ will change the solubility or degree of protonation of surfactant or additive. In this way, the surfactant/water mixture will be switched between sphere-like and worm-like micelles or between having essentially no micelles and having worm-like micelles.

Wormlike micelles are known to be formed by surfactants in water. These types of micelles are long, flexible, approximately cylindrical chains that can entangle into networks, which leads to the viscoelastic properties in fluid. As a result, wormlike micelles have attracted attention in industry as rheology modifiers. Wormlike micelles provide different packing than spherical micelles. The “packing parameter” P is a dimensionless parameter that relates geometrical characteristics of micellar shape based on the properties of the individual surfactant molecules within the micelle. The value of P is given by the following equation:

P=v/a₀l_{c}

where v is the chain hydrophobic volume, a₀ is the effective cross-sectional area per headgroup that the surfactant molecules occupy at the micellar interface and l_{c} is the chain length of the surfactant molecule. Small P values of ˜⅓ or less are indicative of the presence of spherical micelles. P values of from ⅓ to ˜½ are indicative of the presence of cylindrical, or wormlike micelles.

The present application provides a composition and system that allows the use of such wormlike micelles as reversible rheology modifiers. The present compositions and systems comprise water and a switchable component which, as described above can comprise:
(i) a non-switchable surfactant in combination with a switchable water additive;
(ii) a switchable anionic surfactant, such as a carboxylate-containing switchable anionic surfactant; or
(iii) a switchable cationic surfactant, such as an amine or amidine-containing switchable cationic surfactant.

When the switchable component comprises a non-switchable surfactant and a switchable water additive or a switchable cationic surfactant, the addition of dissolved CO₂ to this mixture of water and switchable component results in the formation of wormlike micelles and, consequently, an increase in viscosity. By removal of dissolved CO₂, the mixture will switch to a lower viscosity as the wormlike micelles are disrupted or they convert to spherical micelles or a combination of both.

When the switchable component comprises a switchable anionic surfactant the addition of dissolved CO₂ to the mixture reversibly inhibits formation of wormlike micelles and, consequently, a decrease in viscosity. By removal of the dissolved CO₂ the mixture will switch to a higher viscosity as wormlike micelles are formed.

Depletion of CO₂ from a switchable micellar mixture is obtained by using a non-ionizing trigger such as: by applying heat to the mixture; exposing the mixture to air; exposing the mixture to vacuum or partial vacuum; agitating the mixture; exposing the mixture to a gas or gases that has insufficient CO₂, or other gas, content to convert the non-ionic state to the ionic state (or the ionic state to a non-ionic state in the case of a switchable anionic surfactant); flushing the mixture with a gas or gases that has insufficient CO₂, or other gas, content to convert the non-ionic state to the ionic state; or any combination thereof. A gas that liberates hydrogen ions may be expelled from a solution by simple heating or by passively contacting with a nonreactive gas (“flushing gas”) or with vacuum, in the presence or absence of heating. Alternatively and conveniently, a flushing gas may be employed by bubbling it through the solution to actively expel a gas that liberates hydrogen ions from a solution. In certain situations, especially if speed is desired and if conditions allow, both a flushing gas and heat can be employed in combination as a non-ionizing trigger.

Preferred flushing gases are N₂, air, air that has had its CO₂ component substantially removed, and argon. Less preferred flushing gases are those gases that are costly to supply and/or to recapture, where appropriate. However, in some applications one or more flushing gases may be readily available and therefore add little to no extra cost. In certain cases, flushing gases are less preferred because of their toxicity, e.g., carbon monoxide. Air is a particularly preferred choice as a flushing gas, where the CO₂ level of the air (today commonly 380 ppm) is sufficiently low that an ionic form (e.g., ammonium salt) is not maintained. Untreated air is preferred because it is both inexpensive and environmentally sound. In some situations, however, it may be desirable to employ air that has had its CO₂ component substantially removed as a nonreactive (flushing) gas. Alternatively, some environments may have air with a high CO₂ content, and such flushing gas would not achieve sufficient switching of ionic form to non-ionic amine form. Thus, it may be desirable to treat such air to remove enough of its CO₂ for use as a trigger.

CO₂ can be provided from any convenient source, for example, a vessel of compressed CO₂(g) or as a product of a non-interfering chemical reaction.

To gain a better understanding of the invention described herein, the following examples are set forth. It should be understood that these examples are for illustrative purposes only. Therefore, they should not limit the scope of this invention in any way.

### EXAMPLES

### Example 1

### Switchable Micellar Solution with a Non-Switchable Surfactant

In this example, the switchable nature of a mixture comprising a non-switchable surfactant in the presence of a switchable water additive was explored. The non-switchable surfactant used was sodium hexadecyl sulfate (contains ca. 40% sodium stearyl sulfate) (“Cl6SNa” from TCI America) and the switchable water additive used was 2-(dimethylamino) ethanol (“DMAE”: from Sigma-Aldrich) or N,N,N′,N′-tetramethyl-1,4-diaminobutane (“TMDAB”) was from TCI America). The viscosity measurements were obtained using a digital viscometer (model DV-E, Brookfield).

Table 1 below, shows the change in viscosity when each of the components of the system were tested alone with the addition and removal CO₂.

TABLE 1
Viscosity of surfactant C16SNa and amine additive in
water solution under CO₂ or N₂. Temperature is 60° C.

| | Surfactant C16SNa | | DMAE | | TMDAB | |
|---|---|---|---|---|---|---|
| | (0.2 mol/L) | | (0.2 mol/L) | | (0.1 mol/L) | |
| | Under | Under | Under | Under | Under | Under |
| | CO₂ | N₂ | CO₂ | N₂ | CO₂ | N₂ |
| Viscosity | 1.2 | 1.1 | 1.3 | 1.2 | 1.1 | 1.1 |
| (mPa · s) | | | | | | |

Table 1 shows that the separate aqueous solutions of surfactant and additive had low viscosity when they were not blended together.

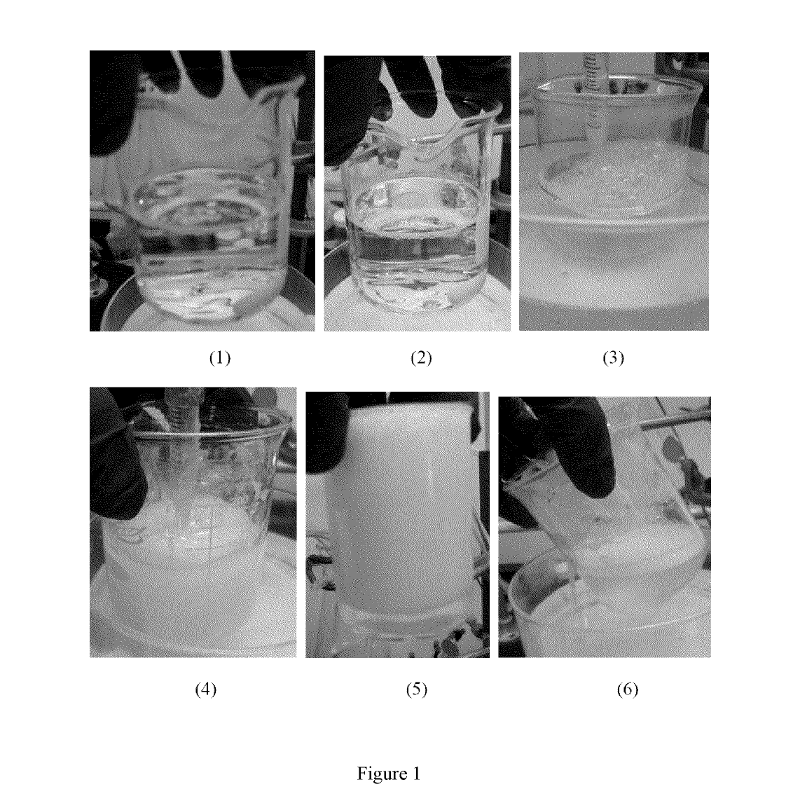

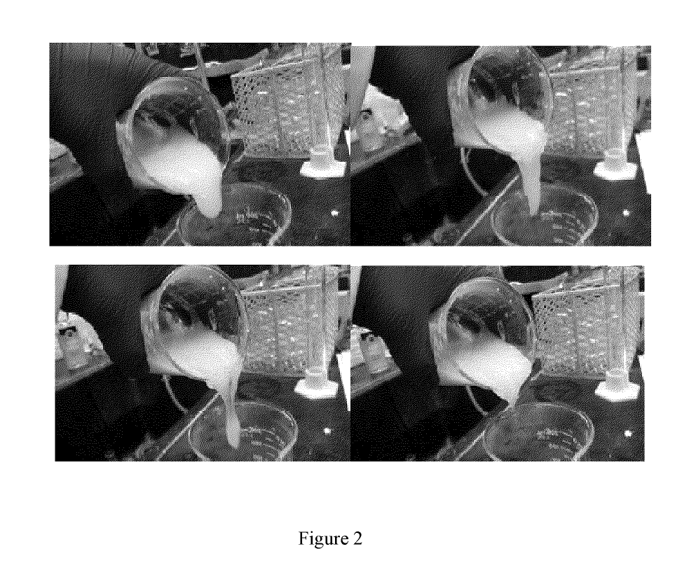

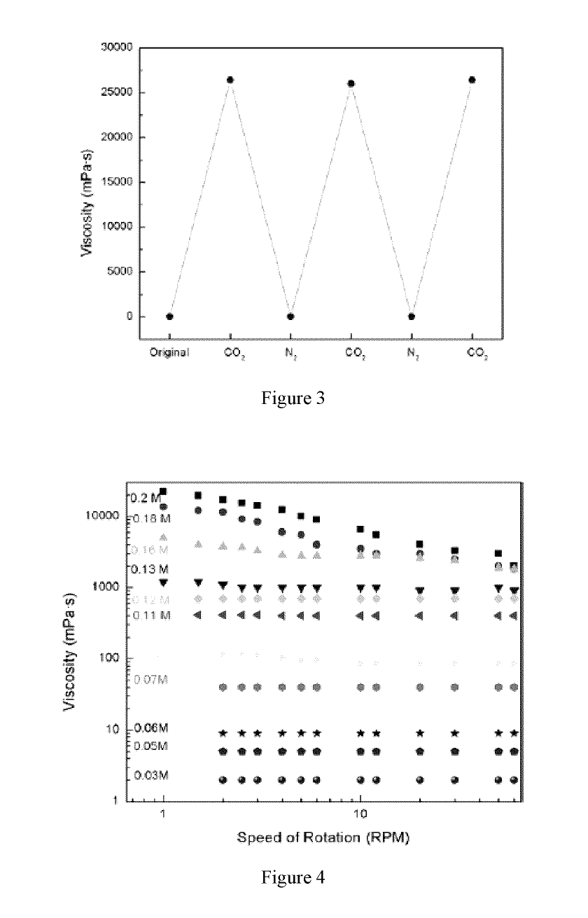

FIG. 1 shows the process of the switchable viscosity controlled by CO₂. In the first photograph (1) the water solution was prepared by adding 6.0 g sodium hexadecyl sulfate to 100 mL distilled water followed by mechanical agitation for several minutes at 60° C. Its viscosity was found to be 1.1 mPa·s. After adding 2.0 g 2-(dimethylamino) ethanol, the viscosity measured is 1.2 mPa·s (photograph (2)). After sparging CO₂ for 15 min at 60° C., the solution formed jelly and its viscosity measured was 26,400 mPa·s (photographs (3) and (4)). After sparging N₂ for 50 min at 60° C., the viscosity switched back to 1.2 mPa·s (photographs (5) and (6)). FIG. 2 shows the slow flowing and high viscosity of mixture of Cl6SNa and DMAE with CO₂. This process of adding CO₂ and then removing CO₂ by sparging with N₂ was repeated. The results are depicted in FIG. 3, which demonstrates the switchable viscosity of this system when this process was repeated.

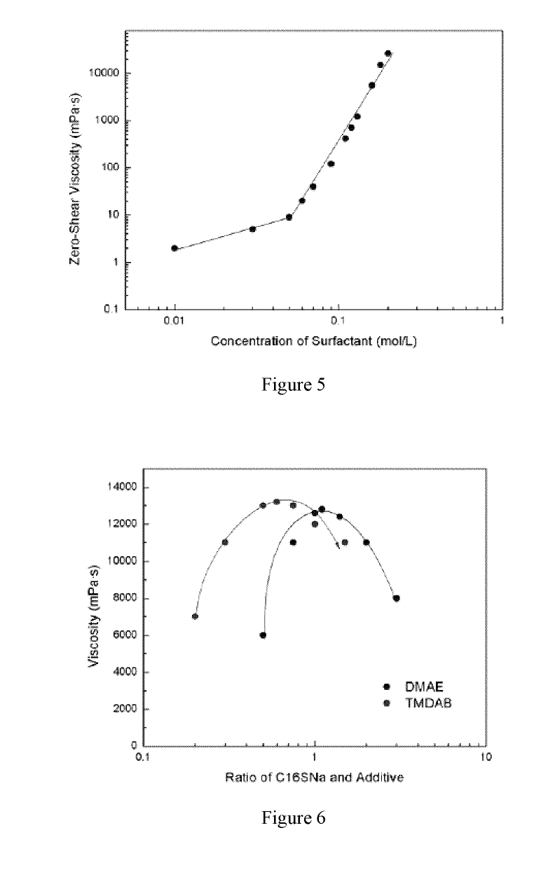

FIGS. 4 and 5 show the viscosity results from the Cl6SNa and switchable water additive DMAE mixture at 60° C. The concentration of DMAE was fixed at 200 mM, while the concentration of the surfactant Cl6SNa was varied. The larger concentrations of surfactant provided higher viscosities.

In order to demonstrate the effect of the switchable water additive concentration on the viscosity, Cl6SNa concentration was fixed at 200 mM and additive was varied (FIG. 6). It was found that once the ratio of surfactant and additive reached a certain point, the viscosity will plateau at a maximum value.

### Example 2

### Switchable Micellar Solution with a Switchable Anionic Surfactant

In this example, the switchable nature of a mixture comprising a switchable anionic surfactant was studied. The switchable anionic surfactant was sodium stearate (“Cl8CNa” from Sigma-Aldrich). The sodium nitrate was also from Sigma-Aldrich.

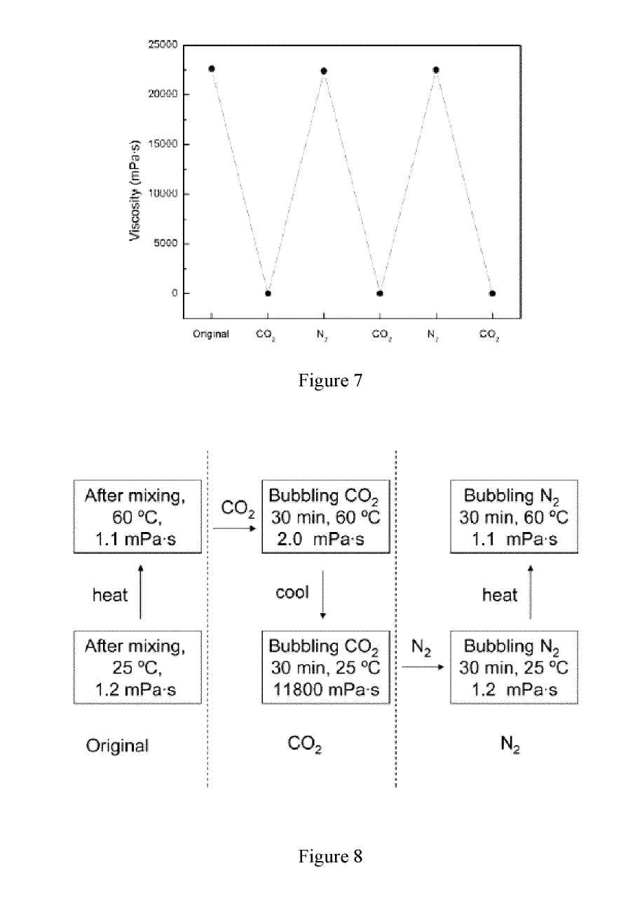

The water solution was prepared by adding 6.0 g sodium stearate to 100 mL and 2.0 g NaNO₃ in distilled water followed by mechanical agitation for 3 h at 60° C. (Table 2). The viscosity measured was 22600 mPa·s. After sparging CO₂ for 10 min at 60° C., the viscous system became milky and its viscosity had reduced to 2.0 mPa·s. After sparging N₂ for about 40 min at 60° C., the viscosity increased back to 22200 mPa·s. This is depicted in FIG. 7 which demonstrates the switchable viscosity of this system when this process was repeated.

TABLE 2
Viscosity of the mixture of surfactant C18CNa and
NaNO₃ in water solution under CO₂ or N2. Temperature is 60° C.

| | Process | Viscosity (mPa · s) |
|---|---|---|
| 1 | After stirring 10 min | 22600 |
| 2 | After bubbling CO₂ 10 min | 2.0 |
| 3 | After bubbling N₂ 40 min | 22200 |

### Example 3

### Switchable Micellar Solution with a Switchable Cationic Surfactant

In this example, the switchable nature of a mixture comprising a switchable cationic surfactant was studied. The switchable cationic surfactant was dimethyloctadecylamine (“Cl8N” from TCI America).

The water solution was prepared by adding 6.5 g Cl8N to 100 mL and 2.0 g NaNO₃ in distilled water followed by mechanical agitation at 60° C. FIG. 8 shows the viscosity measured was 1.1 mPa·s at 60° C., and 1.2 mPa·s at 25° C. After sparging CO₂ for 30 min at 60° C., its viscosity only changed slightly and went up to 2.0 mPa·s. When the temperature was cooled down to 25° C., the viscosity of solution increased to 11800 mPa·s. When sparging N₂ for about 30 min, the viscosity switched back down to 1.1 mPa·s at 60° C. and 1.2 at 25° C. The results are summarized in FIG. 8.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A micellar composition comprising:
(a) a mixture of water and a switchable component comprising:
(i) a non-switchable surfactant and a switchable water additive;
(ii) a switchable anionic surfactant; or
(iii) a switchable cationic surfactant; and
(b) dissolved CO₂,
wherein when the switchable component comprises a non-switchable surfactant and a switchable water additive or a switchable cationic surfactant, the dissolved CO₂ is present at an amount sufficient to reversibly maintain at least a substantial portion of the switchable component in the form of wormlike micelles in the water and removal of the dissolved CO₂ reversibly decreases viscosity of the mixture by disrupting the wormlike micelles and/or converting the wormlike micelles into spherical micelles,
and wherein when the switchable component comprises a switchable anionic surfactant the dissolved CO₂ is present at an amount sufficient to reversibly inhibit formation of wormlike micelles and removal of the dissolved CO₂ reversibly increases viscosity of the mixture by causing the formation of wormlike micelles.

2. The micellar composition of claim 1, wherein the mixture of water and the switchable surfactant component comprises a non-switchable surfactant and a switchable water additive.

3. The micellar composition of claim 2, wherein the switchable water additive comprises an amine moiety, an amidine moiety or a guanidine moiety.

4. The micellar composition of claim 3, wherein the switchable water additive comprises a tertiary amine moiety.

5. The micellar composition of claim 4, wherein the switchable water additive comprises dimethylaminoethanol (DMAE).

6. The micellar composition of any one of claims 2-5, wherein the non-switchable surfactant comprises an anionic surfactant.

7. The micellar composition of claim 6, wherein the anionic surfactant comprises sodium hexadecyl sulfate.

8. The micellar composition of claim 1, wherein the mixture of water and a switchable surfactant component comprises a switchable anionic surfactant.

9. The micellar composition of claim 8, wherein the switchable anionic surfactant comprises a heteroatom that is O, S or Se.

10. The micellar composition of claim 8, wherein the switchable anionic surfactant comprises sodium stearate.

11. The micellar composition of claim 1, wherein the mixture of water and a switchable surfactant component comprises a switchable cationic surfactant.

12. The micellar composition of claim 11, wherein the switchable cationic surfactant comprises an amine moiety, an amidine moiety or a guanidine moiety.

13. The micellar composition of claim 12, wherein the switchable cationic surfactant comprises an amine moiety.

14. The micellar composition of claim 13, wherein the switchable cationic surfactant comprises octadecylamine.

15. A method of modifying the viscosity of water or an aqueous solution comprising the steps of:
(a) combining, in any order, the water or aqueous solution and a switchable component to form a first mixture having a first viscosity, wherein the switchable component is:
(i) a non-switchable surfactant and a switchable water additive;
(ii) a switchable anionic surfactant; or
(iii) a switchable cationic surfactant; and
(b) contacting the first mixture with CO₂ such that the CO₂ dissolves in the first mixture to form a second mixture having a second viscosity,
wherein when the switchable component comprises a non-switchable surfactant and a switchable water additive, or a switchable cationic surfactant, the dissolved CO₂ is present at an amount sufficient to reversibly maintain at least a substantial portion of the switchable component in the form of wormlike micelles in the water and which reversibly increases the viscosity of the second mixture over that of the first mixture,
and wherein when the switchable component comprises a switchable anionic surfactant the dissolved CO₂ is present at an amount sufficient to reversibly inhibit formation of wormlike micelles and decrease the viscosity of the second mixture to less than that of the first mixture.

16. The method of claim 15, wherein the mixture of water and the switchable component comprises a non-switchable surfactant and a switchable water additive.

17. The method of claim 16, wherein the switchable water additive comprises an amine moiety, an amidine moiety or a guanidine moiety.

18. The method of claim 17, wherein the switchable water additive comprises a tertiary amine moiety.

19. The method of claim 18, wherein the switchable water additive comprises dimethylaminoethanol (DMAE).

20. The method of any one of claims 16-19, wherein the non-switchable surfactant comprises an anionic surfactant.

21. The method of claim 20, wherein the anionic surfactant comprises sodium hexadecyl sulfate.

22. The method of claim 15, wherein the mixture of water and a switchable component comprises a switchable anionic surfactant.

23. The method of claim 22, wherein the switchable anionic surfactant comprises a heteroatom that is O, S or Se.

24. The method of claim 22, wherein the switchable anionic surfactant comprises sodium stearate.

25. The method of claim 15, wherein the mixture of water and a switchable component comprises a switchable cationic surfactant.

26. The method of claim 25, wherein the switchable cationic surfactant comprises an amine moiety, an amidine moiety or a guanidine moiety.

27. The method of claim 26, wherein the switchable cationic surfactant comprises an amine moiety.

28. The method of claim 27, wherein the switchable cationic surfactant comprises octadecylamine.
